(19) United States
(12) Patent Application Publication
(10) Pub. No.: US 2012/0054830 A1
(43) Pub. Date: Mar. 1, 2012

(54) Network Relay Device and Relay Control Method of Received Frames

(75) Inventor: Daisuke Yamada, Nagoya-shi (JP)

(73) Assignee: BUFFALO INC., Nagoya-shi (JP)

(21) Appl. No.: 13/215,240

(22) Filed: Aug. 23, 2011

(30) Foreign Application Priority Data
Aug. 24, 2010 (JP) 2010-186826

(51) Int. Cl. G06F 21/00; G06F 15/16

(52) U.S. Cl. 726/3

(57) ABSTRACT

A network relay device includes: an authentication process section for conducting, when a separate network relay device is connected to the network relay device, mutual authentication between the network relay device and the separate network relay device in accordance with an authentication protocol determined in an authentication protocol list; and a relay process section for determining whether frames received by the network relay device is eligible to be relayed in accordance with a permission list, and for relaying received frames determined to be eligible to be relayed. On a condition that the mutual authentication by the authentication process section has been successful, the relay process section also relays, through the network relay device, frames received from the separate network relay device.

### CROSS REFERENCE TO RELATED APPLICATION

The disclosure of Japanese Patent Application No. 2010-186826, filed on Aug. 24, 2010, is incorporated herein by reference.

### BACKGROUND OF THE INVENTION

1. Field of the Invention

The present invention relates to network relay devices and methods that the network relay devices execute for controlling relay of received frames.

2. Description of the Background Art

Accompanying advances in information and communications technology (ICT), switching products known as intelligent switches have appeared. Such intelligent switches signify switching that is highly functional by comparison to general switches. Intelligent switches have a variety of functions including, for example, virtual local area network (VLAN) functions, security functions, and functions related to quality of service (QoS) (cf., for example, Japanese Laid-Open Patent Publication No. 2008-48252). Among the functions described above, the strengthening of security functions in particular that place a premium on threats within networks has been in demand in recent years.

Widely used in general as a security function that stresses the importance of threats within a network is a function called port-level security that restricts input of traffic, based on MAC addresses stored in external devices connected to intelligent-switch ports.

With the conventional technology, however, even when port-level security functions are adopted in intelligent switches, the ports for cascade connections whereby the intelligent switches are connected to each other in cascades are established an open state, that is, in a state in which there are no security restrictions on the input of traffic. This has led to the problem of the ports for cascade connections becoming security holes.

What is more, this sort of problem has not been limited to intelligent switches, but on the whole has been a problem common to network relay devices with security functions.

### SUMMARY OF THE INVENTION

Therefore, an object of the present invention is to make available network relay devices, and methods that the network relay devices execute for controlling relay of received frames, in which security is improved by.

The present invention is directed toward a network relay device that relays frames received from external devices. In addition, in order to achieve the above described object, the network relay device of the present invention includes: an authentication process section for conducting, when a separate network relay device is connected to the network relay device as an external device, mutual authentication between the network relay device and the separate network relay device in accordance with an authentication protocol that is determined in advance; and a relay process section for determining whether frames that said network relay device receives from an external device are relay-eligible, and for relaying received frames determined to be relay-eligible, wherein on the condition that the mutual authentication by the authentication process section has been successful, the relay process section relays, through said network relay device, the frames received from the separate network relay device under.

By adopting such a configuration, security of the network relay device can be improved.

Representatively, the network relay device further includes a storing section storing a first permission list for using information included in the received frames to designate, frames eligible for relaying through the network relay device. The relay process section includes: an authentication information management section for transmitting content of the first permission list to a separate network relay device between which mutual authentication has been successful, and for receiving, from the separate network relay device between which the mutual authentication has been successful, content of a second permission list for designating in the separate network relay device relay-eligible frames, and reflecting the content of the received second permission list onto the first permission list; and a determination process section for determining, in accordance with the second-list reflected first permission list, whether frames received from an external device are relay-eligible.

By adopting such a configuration, security of the network relay device can be improved.

Here, the storing section further stores first virtual-network-defining information defining a virtual subnetwork built by an external device connected to said network relay device either directly, or indirectly via a separate network relay device. The authentication information management section further transmits content of the first virtual-network-defining information to a separate network relay device between which mutual authentication has been successful, and further receives, from the separate network relay device between which the mutual authentication has been successful, content of second virtual-network-defining information defining a virtual subnetwork built by an external device connected to the separate network relay device either directly, or indirectly via still another separate network relay device, and reflects the content of the received second virtual-network-defining information onto the first virtual-network-defining information.

By adopting such a configuration, settings of a virtual subnetwork can be easily configured while improving security of the network relay device.

In addition, the authentication process section may furthermore conduct, when a frame-transmitting terminal is connected as an external device to said network relay device, mutual authentication between said network relay device and the terminal in accordance with an authentication protocol that is determined in advance. The authentication information management section may furthermore change, if the mutual authentication with the terminal has been successful, the content of the first permission list so as to permit relaying of frames received from the terminal, and may furthermore transmit the content of the changed first permission list to the separate network relay device between which the mutual authentication has been successful.

By adopting such a configuration, security of the network relay device can be improved.

In the case described above, the authentication information management section may further transmit, if the mutual authentication with the terminal has been successful, the content of the first virtual-network-defining information to the separate network relay device between which the mutual authentication has been successful.

By adopting such a configuration, updating the settings of the virtual subnetwork can be easily conducted while improving security of the network relay device.

The authentication process section preferably has functions of both an authentication client based on IEEE 802.1X and an authentication server based on IEEE 802.1X.

By adopting such a configuration, the network relay device can behave as an authentication client and an authentication server with respect to the separate network relay device.

Furthermore, when the separate network relay device is connected to the network relay device and when a MAC address of the separate network relay device is registered in the network relay device as a MAC address to be permitted for connection, the authentication process section preferably treats the separate network relay device as a partner between which mutual authentication has been successful.

By adopting such a configuration, the network relay device can designate in advance separate network relay devices that should be permitted for connection.

In addition, the present invention is directed toward a method executed by a network relay device for controlling relay of frames received from external devices. In order to achieve the above described object, the relay control method of the present invention includes: a step of judging whether an external device connected to the network relay device is a separate network relay device; a step of conducting, when the connected external device is a separate network relay device, mutual authentication between the network relay device and the separate network relay device in accordance with an authentication protocol that is determined in advance; a step of exchanging, with the separate network relay device when the authentication between the network relay device and the separate network relay device is successful, contents of permission lists which are stored in advance to designate, using information included in received frames, frames that are relay-eligible; a step of reflecting content of a permission list acquired by an exchange and stored in the separate network relay device between which the mutual authentication has been successful, onto a permission list stored in the network relay device; and a step of determining, in accordance with the reflected permission list, whether frames received from the external device are relay-eligible.

Furthermore, the method may also include: a step of judging whether the external device connected to the network relay device is a terminal that transmits frames; a step of conducting, when the connected external device is a terminal, mutual authentication between the network relay device and the terminal in accordance with an authentication protocol that is determined in advance; a step of changing, if the mutual authentication with the terminal has been successful, content of the permission list stored in the network relay device so as to permit relay of frames received from the terminal, and transmitting the content of the changed permission list to the separate network relay device between which the mutual authentication has been successful.

By adopting such a relay control method, security of the network relay device can be improved.

It should be noted that the present invention can be attained in various modes. For example, the present invention can be attained in modes including network relay devices, methods for controlling network relay devices, network systems using network relay devices, and computer programs that achieve the functions of these methods or devices, and storage media having stored therein such computer programs.

The present invention is applicable to network systems and the like including a relay device and a wireless communication device; and is particularly useful when there is a need to improve security for wireless communications. These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a schematic configuration of a network relay device and a terminal according to a first embodiment of the present invention;

FIG. 2 schematically shows the configuration of the network relay device according to the first embodiment;

FIG. 3 shows one example of an authentication protocol list;

FIG. 4 shows one example of a permission list;

FIG. 5 is a flowchart showing process steps conducted by the network relay device according to the first embodiment of the present invention when a frame is received;

FIG. 6 shows a situation prior to having mutual authentication conducted with a separate network relay device that has been connected to the network relay device according to the first embodiment;

FIG. 7 is a sequence diagram showing a flow of a process conducted when the type of authentication at step S16 in FIG. 5 is EAP_CAS;

FIG. 8 shows a situation after having mutual authentication conducted with the separate network relay device connected to the network relay device according to the first embodiment;

FIG. 9 shows a situation where a new external device is connected to the network relay device in a state shown in FIG. 8;

FIG. 10 is a sequence diagram showing a flow of a process conducted when the type of authentication at step S16 in FIG. 5 is EAP_PC;

FIG. 11 shows a situation after having mutual authentication conducted with the external device that has been newly connected to the network relay device;

FIG. 12 schematically shows a configuration of a network relay device according to a second embodiment of the present invention;

FIG. 13 shows one example of VLAN defining information;

FIG. 14 shows a situation prior to having mutual authentication conducted with a separate network relay device that has been connected to the network relay device according to the second embodiment;

FIG. 15 is a sequence diagram showing a flow of a process (step S16 in FIG. 5: type of authentication is EAP_CAS) conducted when the separate network relay device is connected to the network relay device according to the second embodiment; and

FIG. 16 shows a situation after having mutual authentication conducted with the separate network relay device that has been connected to the network relay device according to the second embodiment.

### DESCRIPTION OF THE PREFERRED EMBODIMENTS

Embodiments of the present invention will be described in the following with reference to the drawings.

### First Embodiment

FIG. 1 shows a schematic configuration of a terminal PC10, a terminal PC20, and a network relay device 100 according to a first embodiment of the present invention. The network relay device 100 according to the first embodiment is a so-called layer 2 switch, and has a function of relaying a frame using a MAC (Media Access Control) address. Layer 2 corresponds to the second layer (data link layer) of the OSI (Open Systems Interconnection) reference model. In the following, descriptions are provided by rephrasing the network relay device 100 as a switch 100.

The switch 100 includes five ports, P501 to P505. The terminal PC10, which is a personal computer or the like, is connected to the port P501 via a line. The MAC address of the terminal PC10 is MAC_PC10. The terminal PC20, which is a personal computer or the like, is connected to the port P502 via a line. The MAC address of the terminal PC20 is MAC_PC20. It should be noted that, those that are unnecessary for the descriptions, such as other network devices, lines, terminals, and the internal configuration of the switch 100, are not diagrammatically represented in FIG. 1 for convenience. The same applies for all the figures described later.

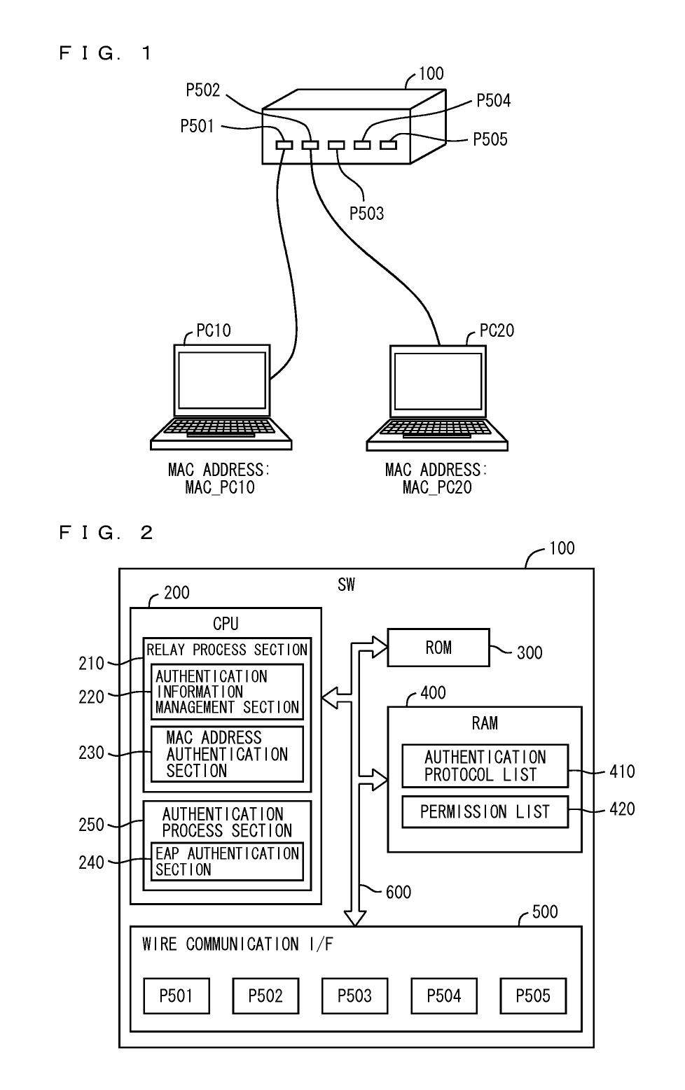

FIG. 2 schematically shows the configuration of the switch 100 according to the first embodiment. The switch 100 includes a CPU (Central Processing Unit) 200, a ROM (Read Only Memory) 300, a RAM (Random Access Memory) 400, and a wire communication interface (wire communication I/F) 500. All the components of the switch 100 are connected to each other via a bus 600.

The CPU 200 controls each section of the switch 100 by loading a computer program stored in the ROM 300 onto the RAM 400 and executing the computer program. In addition, by having the above described computer program executed, the CPU 200 also functions as a relay process section 210 and an authentication process section 250. The relay process section 210 includes an authentication information management section 220 and a MAC address authentication section 230, and has a function of relaying a frame received (described as a received frame in the following) via a wire communication interface 500. The main functions of the authentication information management section 220 include a function of updating a permission list 420 stored in the RAM 400 which is a storing section, and a function of exchanging the permission list 420 with another switch. The MAC address authentication section 230 functions as a determination process section for conducting a process of determining whether the received frame is eligible to be relayed. An EAP authentication section 240, which is included in the authentication process section 250, has a function of conducting, when an external device (e.g., a terminal or another switch) is connected to the switch 100, mutual authentication between the switch 100 and the external device in accordance with an authentication protocol that is determined in advance. Details of each of these functional sections will be described later.

An authentication protocol list 410 and the permission list 420 are stored in the RAM 400. Details of each of these lists will be described later. The wire communication interface 500 is a connection opening for a LAN cable, and is used to connect to a local area network (LAN). The wire communication interface 500 includes the five ports, P501 to P505. In the present embodiment, the ports P501 to P504 are ports used for connecting to external devices (e.g., personal computers, mobile terminals, and the like) other than a switch. The port P505 is a port used for connecting to other switches in cascade.

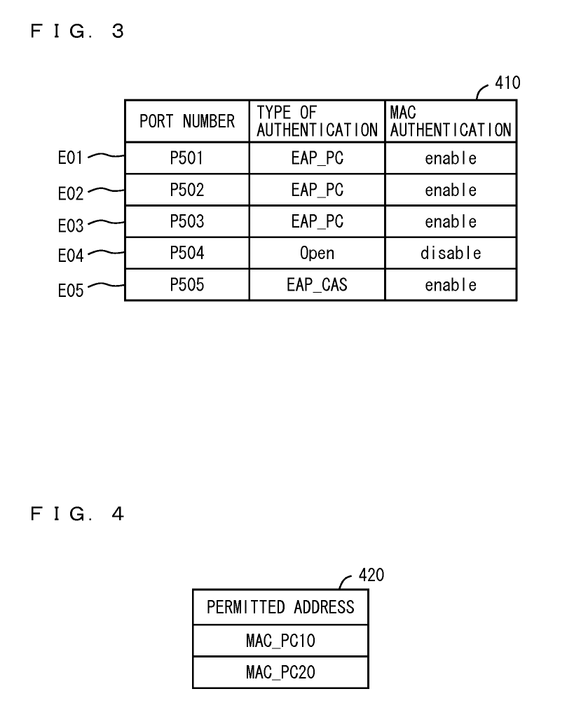

FIG. 3 shows one example of the authentication protocol list 410. The authentication protocol list 410 includes a port number field, an authentication type field, and a MAC authentication field. Identifiers of all the ports included in the switch 100 are stored as entries of the port number field. The identifiers in the present embodiment are “P501” to “P505.”

Stored in the authentication type field is data indicating the type of authentication which is determined in advance for each of the ports whose identifiers are stored in the port number field. The type of authentication refers to the type of authentication conducted by the EAP authentication section 240 when an external device (a terminal or another switch) is connected to a port. Three types of authentication are used in the present embodiment, “EAP_PC,” “EAP_CAS,” and “Open.” EAP_PC represents mutual authentication between the switch and an external device other than a switch. EAP_CAS represents mutual authentication between switches. Open represents an absence of any authentications. Furthermore, various data for executing authentication protocols that are actually used in respective types of authentication are stored in the RAM 400 in advance. In the present embodiment, when the type of authentication is EAP_PC, the authentication is conducted by using EAP-MD5 (extensible authentication protocol-message digest version 5) of IEEE (Institute of Electrical and Electronics Engineers) 802.1X. On the other hand, when the type of authentication is EAP_CAS, the authentication is conducted by using EAP-TLS (extensible authentication protocol-transport layer security) of IEEE 802.1X. Furthermore, a user may be given an ability to configure the type of authentication that is actually used in the authentication protocol.

Stored in the MAC authentication field are setting values to “enable” or “disable” a MAC address authentication; and the setting values are predetermined for each of the ports whose identifiers are stored in the port number field.

For example, it is specified in FIG. 3 that, when an external device is connected to the port P501 which is identified by an identifier P501, an authentication based on EAP_PC, that is, an authentication in accordance with the EAP-MD5 authentication protocol, will be conducted. In addition, it is specified that a MAC address authentication will be conducted on a frame received through the port P501 (entry E01). It is also specified that an authentication will not be conducted when an external device is connected to the port P504 which is identified by an identifier P504. In addition, it is specified that a MAC address authentication will not be conducted on a frame received through the port P504 (entry E04). It is also specified that, when an external device is connected to the port P505 which is identified by an identifier P505, an authentication based on EAP CAS, that is, an authentication in accordance with the EAP-TLS authentication protocol, will be conducted. In addition, it is specified that a MAC address authentication will be conducted on a frame received through the port P505 (entry E05).

In order to correctly relay a received frame, the MAC address authentication is set as “disable” for a port whose type of authentication is set as “Open” as in entry E04. Therefore, for a port whose type of authentication is set as “Open,” the switch 100 will not conduct an authentication when an external device has been connected and will not conduct a MAC address authentication on a received frame. As a result, a port whose type of authentication is set as “Open” may become a security hole.

FIG. 4 shows one example of the permission list 420. The permission list 420 is a list used when conducting a MAC address authentication. A transmission source MAC address is a MAC address of a device that has transmitted a frame to the switch 100. Stored in the permission list 420 as permitted addresses are transmission source MAC addresses from which frames that will be permitted by the relay process section 210 of the switch 100 for relaying are received. Thus, the permission list 420 is configured such that a received frame eligible to be relayed can be specified by using the information included in the received frame.

For example, in FIG. 4, if the transmission source MAC address included in a header of a received frame is either “MAC_PC10” or “MAC_PC20”, relaying of the received frame will be permitted by the relay process section 210.

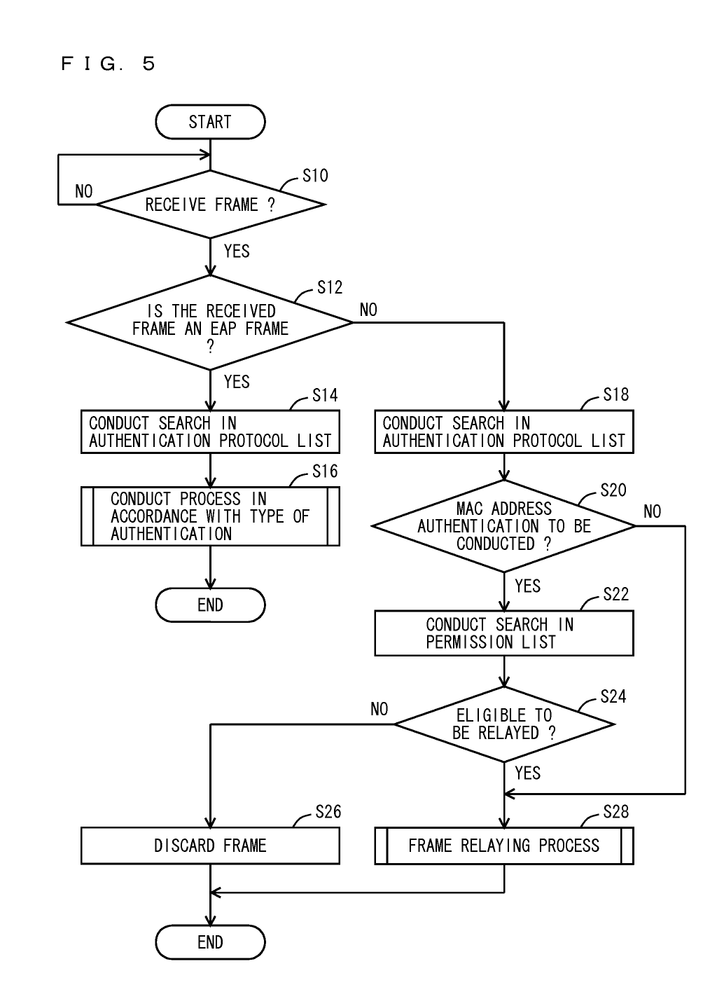

Next, a frame reception process, which includes process steps conducted by the switch 100 of the above described configuration when a frame is received, will be described. FIG. 5 is a flowchart showing process steps of the frame reception process conducted by the network relay device (switch) 100 according to the first embodiment of the present invention.

First, the relay process section 210 determines whether a frame has been received through any one of the ports P501 to P505 (step S10). When a frame is received (step S10: YES), the relay process section 210 judges whether or not the received frame is an EAP frame (step S12). Specifically, for example, when the type of the received frame, which is determined from an EtherType included in the header of the received frame, is EAPOL (extensible authentication protocol over LAN); the relay process section 210 can judge that an EAP frame has been received.

When the received frame is judged as an EAP frame (step S12: YES), the EAP authentication section 240 conducts a search in the authentication type field of the authentication protocol list 410 (step S14). Specifically, the EAP authentication section 240 refers to the authentication protocol list 410, and acquires a value in the authentication type field from an entry that has, in the port number field, the identifier of the port through which the frame has been received. The EAP authentication section 240 conducts a process in accordance with the acquired type of authentication, and ends the process (step S16). Details of the processes in accordance with respective types of authentications (EAP_PC, EAP_CAS) will be described later.

On the other hand, when the received frame is judged as not being an EAP frame (step S12: NO), the MAC address authentication section 230 conducts a search in the MAC authentication field of the authentication protocol list 410 (step S18). Specifically, the MAC address authentication section 230 refers to the authentication protocol list 410, and acquires a value in the MAC authentication field from an entry that has, in the port number field, the identifier of the port through which the frame has been received; more specifically, acquires a setting value to “enable”/“disable” the MAC address authentication. Next, the MAC address authentication section 230 judges whether or not to conduct a MAC address authentication based on the acquired setting value (step S20). Specifically, the MAC address authentication section 230 conducts the MAC address authentication if the acquired setting value is “enable,” and does not conduct the MAC address authentication if the acquired setting value is “disable.” When the MAC address authentication is not being conducted (step S20: NO), the MAC address authentication section 230 conducts a frame relaying process (step S28).

When it is judged to conduct the MAC address authentication (step S20: YES), the MAC address authentication section 230 refers to the permission list 420 (step S22), and judges whether or not the received frame is eligible to be relayed (step S24). Specifically, the MAC address authentication section 230 judges whether or not the transmission source MAC address included in the header of the received frame matches any one of the MAC addresses stored in the permission list 420. When there are no matches in the MAC addresses and when it is judged that the received frame is not eligible to be relayed (step S24: NO), the MAC address authentication section 230 discards the received frame and ends the process (step S26). After discarding the received frame, the MAC address authentication section 230 may notify the source terminal from which the discarded frame has been transmitted about the discarding of the frame.

On the other hand, when it is judged not to conduct the MAC address authentication at step S20 described above (step S20: NO), and when there is a match in the MAC addresses and it is judged that the received frame is eligible to be relayed at step S24 described above (step S24: YES), the MAC address authentication section 230 conducts a frame relaying process (step S28). In this frame relaying process, the relay process section 210 refers to a MAC address table which is not shown, and conducts forwarding (a frame relaying operation conducted when a destination MAC address is in the MAC address table) or flooding (an operation conducted when the destination MAC address is not in the MAC address table), and then ends the process. As described above, the MAC address authentication section 230 of the relay process section 210 determines whether the received frame is eligible to be relayed based on the permission list 420.

### 1. Specific Example 1 of the Frame Reception Process

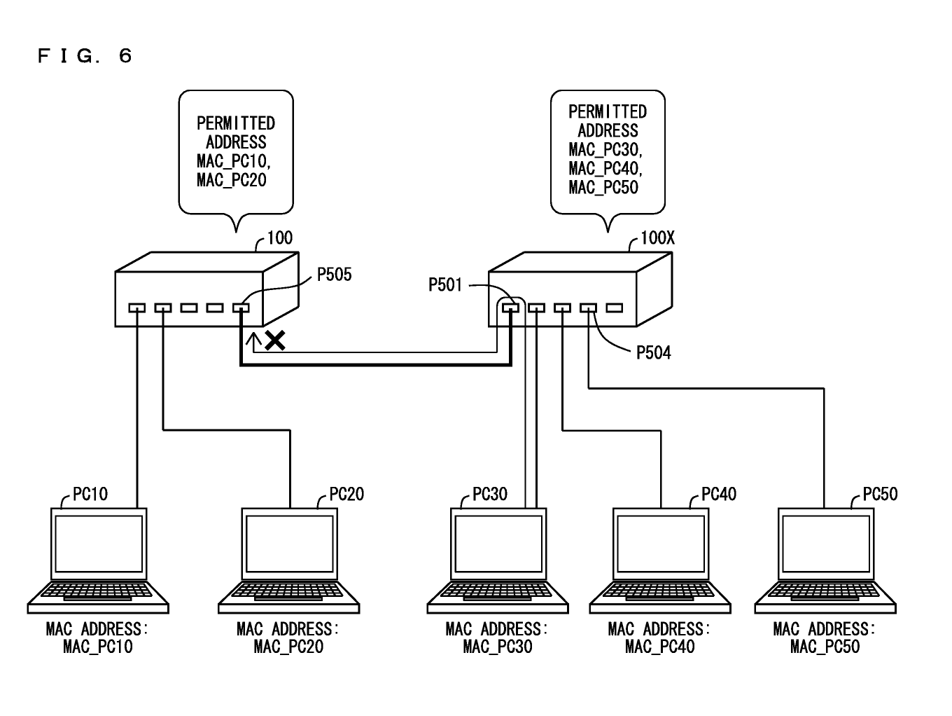

A specific example 1 of the frame reception process conducted by the switch 100 will be described by further referring to FIG. 6 to FIG. 8. FIG. 6 to FIG. 8 show an example in which a port P501 of another switch 100X is connected to the port P505 of the switch 100. The configuration of the other switch 100X is similar to that of the switch 100 shown in FIG. 2, except that the port P501 is set as a port for cascade connection. With regard to the ports of the other switch 100X, the port P501 has the port P505 of the switch 100 connected thereto, a port P502 has a terminal PC30 connected thereto, a port P503 has a terminal PC40 connected thereto, a port P504 has a terminal PC50 connected thereto, and all connections are formed via lines. In addition, the MAC address of the terminal PC30 is MAC_PC30, the MAC address of the terminal PC40 is MAC_PC40, and the MAC address of the terminal PC50 is MAC_PC50.

In addition, set in an authentication protocol list 410 included in the other switch 100X are authentication type “EAP_CAS” and MAC authentication “enable” for the port P501, and authentication type “EAP_PC” and MAC authentication “enable” for the port P502. Furthermore, stored in a permission list (in this specific example, referred to as a second permission list) 420 included in the other switch 100X are the MAC addresses (MAC_PC30, MAC_PC40, and MAC_PC50) of the three terminals (PC30, PC40, and PC50) connected to the other switch 100X. The terminals connected to each of the ports of the switch 100, and the authentication protocol list 410 and the permission list (in this specific example, referred to as a first permission list) 420 included in the switch 100 are as shown in FIG. 1, FIG. 3, and FIG. 4.

### 1-1. Prior to having Mutual Authentication Conducted between the Switches

As an example, as shown in FIG. 6, discussed in the following is a case in which a frame is transmitted from the terminal PC30 to the terminal PC20 before mutual authentication is conducted between the switch 100 and the other switch 100X.

First, the other switch 100X detects a frame received from the terminal PC30 (step S10 in FIG. 5: YES). Since the received frame that has been detected is not an EAP frame (step S12: NO), the other switch 100X refers to the authentication protocol list 410 and determines that the MAC address authentication is enabled for the port P502 that received the frame (step S18, step S20). Next, the other switch 100X verifies that MAC_PC30, which is a transmission source MAC address, matches a MAC address stored in the second permission list 420, and judges that the received frame is eligible to be relayed (step S22, step S24: YES). Then, the other switch 100X conducts a frame relaying process (step S28). As a result, the frame received by the other switch 100X is transmitted from the port P501 of the other switch 100X to the switch 100.

The switch 100 that received the frame from the other switch 100X (step S10 in FIG. 5: YES) judges that the received frame is not an EAP frame (step S12: NO). Next, the switch 100 refers to the authentication protocol list 410, and determines that the MAC address authentication at the port P505 through which the frame has been received is enabled (step S18, step S20). However, the switch 100 verifies that MAC_PC30, which is the transmission source MAC address, does not match any of the MAC addresses stored in the first permission list 420, and judges that the received frame is not eligible to be relayed (step S22, step S24: NO). As a result, the frame received by the switch 100 via the other switch 100X is discarded by the switch 100 (step S26).

As described above, prior to having mutual authentication between the switch 100 and the other switch 100X conducted, the switch 100 does not relay a frame received from an external device connected to the other switch 100X, and discards the frame. In other words, prior to having mutual authentication conducted with the other switch 100X, the switch 100 restricts an input of traffic from the other switch 100X. This occurs when a MAC address of an external device (the terminal PC30 to the terminal PC50) connected to the other switch 100X is not stored in the first permission list 420 included in the switch 100.

### 1-2. Authentication Process between the Switches

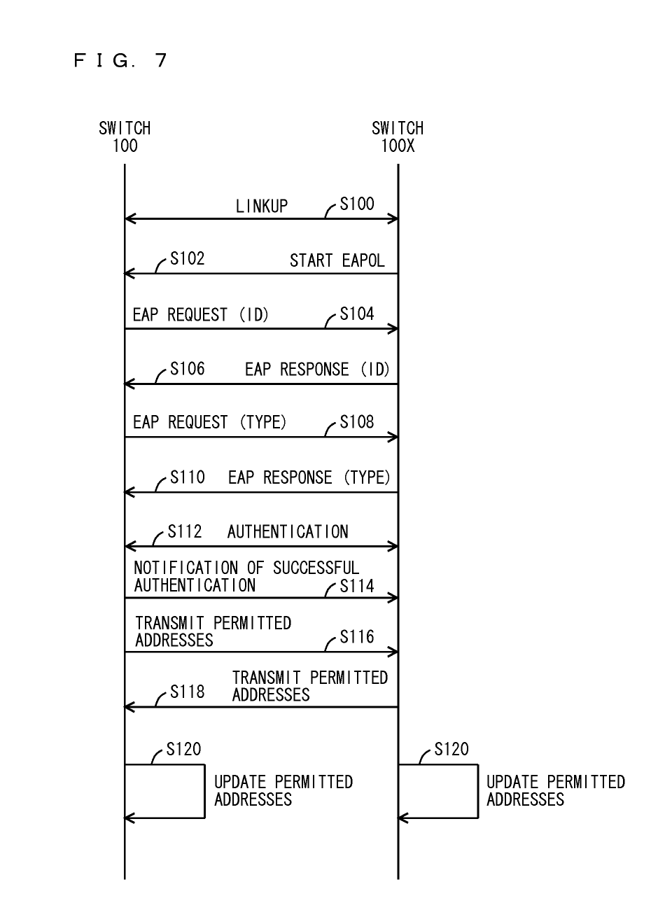

Mutual authentication between the switch 100 and the other switch 100X is conducted as described in the following. FIG. 7 is a sequence diagram showing a flow of a process conducted between the switches when the type of authentication is EAP_CAS at step S16 in FIG. 5.

When the other switch 100X is connected to the switch 100, a linkup is conducted between the two switches at the beginning (step S100). Next, an EAPOL-start (EAP over LAN-Start) frame for requesting an authentication to start is transmitted from the other switch 100X acting as a supplicant to the switch 100 acting as an authenticator (step S102).

The EAP authentication section 240 of the switch 100 which received the EAPOL-start frame judges that the received frame is an EAP frame, and transmits, to the other switch 100X, an EAP request frame requesting an ID of the supplicant (step S104). The other switch 100X that has received the request frame transmits an EAP response frame including the ID of the supplicant to the switch 100 (step S106). Next, the EAP authentication section 240 of the switch 100 transmits the EAP request frame for notifying the type of EAP to be used for the authentication (in the present embodiment, EAP-TLS) to the other switch 100X (step S108). The other switch 100X which has received the request frame transmits an EAP response frame including an identifier of the type of EAP to be used for the authentication to the switch 100 (step S110).

Then, mutual authentication conforming to the authentication protocol notified at step S110 is conducted between the switch 100 and the other switch 100X (step S112). When the authentication is successful, the EAP authentication section 240 of the switch 100 transmits, to the other switch 100X, an EAP frame regarding the success of the authentication (step S114). It should be noted that each of the frames described above has a configuration conforming to the format predetermined by the rules of EAP; and the values of IDs, types, and the like are transmitted and received as data stored in specified positions within the frames.

After the success of the authentication, the authentication information management section 220 of the switch 100 transmits a frame including permitted addresses stored in the first permission list 420 to the other switch 100X (step S116). The other switch 100X that has received this frame transmits, to the switch 100, a frame including permitted addresses stored in the second permission list 420 of the other switch 100X (step S118). Lastly, the authentication information management section 220 of the switch 100 updates the permitted addresses stored in the first the permission list 420 of the switch 100 based on the permitted addresses included in the received frame. Specifically, the authentication information management section 220 adds the permitted addresses (MAC addresses) included in the received frame to the first permission list 420. Similarly, the other switch 100X updates the permitted addresses stored in the second permission list 420 of the other switch 100X based on the permitted addresses included in the received frame.

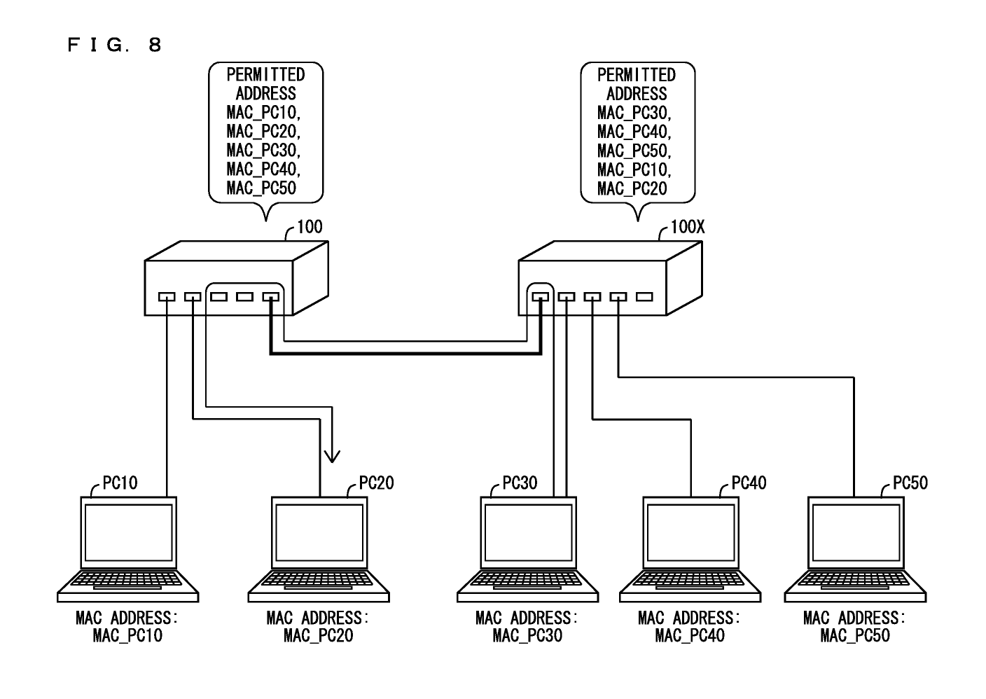

In this example, in addition to the permitted addresses (MAC_PC10 and MAC_PC20) of the two terminals (PC10 and PC20) connected to the switch 100, permitted addresses (MAC_PC30, MAC_PC40, and MAC_PC50) stored in the second permission list 420 included in the other switch 100X are stored in the first permission list 420 included in the switch 100 (FIG. 8). Similarly, in addition to the MAC addresses (MAC_PC30, MAC_PC40, and MAC_PC50) of the three terminals (PC30, PC40, and PC50) connected to the other switch 100X, permitted addresses (MAC_PC10 and MAC_PC20) stored in the first permission list 420 included in the switch 100 are stored in the second permission list 420 included in the other switch 100X (FIG. 8).

In FIG. 7, although the other switch 100X functions as an authentication client (supplicant) based on IEEE 802.1X and the switch 100 functions as an authentication server (authenticator) based on IEEE 802.1X, the functions may be reversed. For example, a configuration can be adopted where the switch 100 transmits an EAPOL-start frame to the other switch 100X when the switch 100 does not receive an EAPOL-start frame within a certain period of time after detecting the linkup (step S100). In this case, the switch 100 functions as an authentication client and the other switch 100X functions as an authentication server. As described here, if the EAP authentication section 240 functions both as an authentication client based on IEEE 802.1X and an authentication server based on IEEE 802.1X, the switch 100 can behave as an authentication client and an authentication server with respect to the other switch 100X, and thereby a highly flexible authentication can be conducted.

### 1-3. After having Mutual Authentication Conducted between the Switches

As shown in FIG. 8, discussed in the following is a case in which a frame is transmitted from the terminal PC30 to the terminal PC20 after mutual authentication is conducted between the switch 100 and the other switch 100X. In this case, the flow of the process up to the transmission of the frame from the terminal PC30 to the switch 100 via the other switch 100X is identical to that described in FIG. 6.

The switch 100 that received the frame from the other switch 100X (step S10 in FIG. 5: YES) judges that the received frame is not an EAP frame (step S12: NO). Next, the switch 100 refers to the authentication protocol list 410, and determines that the MAC address authentication at the port P505 through which the frame has been received is enabled (step S18, step S20). Furthermore, the switch 100 verifies that MAC_PC30, which is the transmission source MAC address, matches a MAC address stored in the first permission list 420, and judges that the received frame is eligible to be relayed (step S22, step S24: YES). Then, the switch 100 conducts the frame relaying process (step S28). As a result, the frame received by the switch 100 via the other switch 100X is transmitted from the port P502 of the switch 100 to the terminal PC20.

As described above, when mutual authentication between the switch 100 and the other switch 100X is conducted and after the mutual authentication is successful, the switch 100 relays a frame received from an external device connect to the other switch 100X. In other words, the switch 100 does not restrict an input of traffic from the other switch 100X on a condition that the mutual authentication has been successful with the other switch 100X.

### 2. Specific Example 2 of the Frame Reception Process

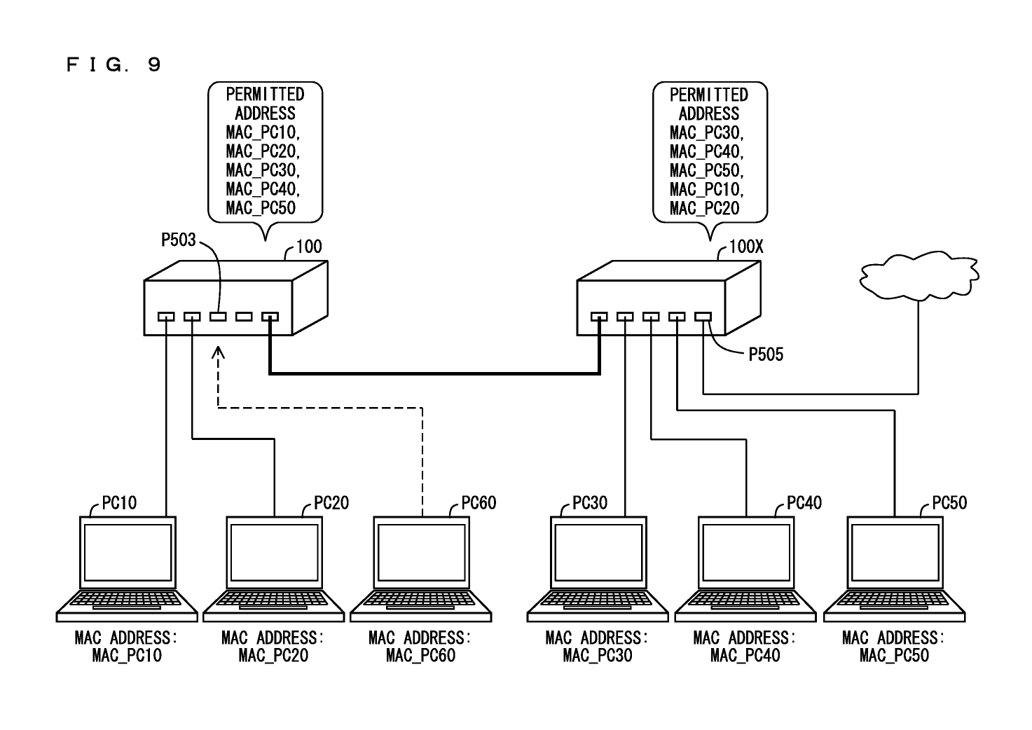

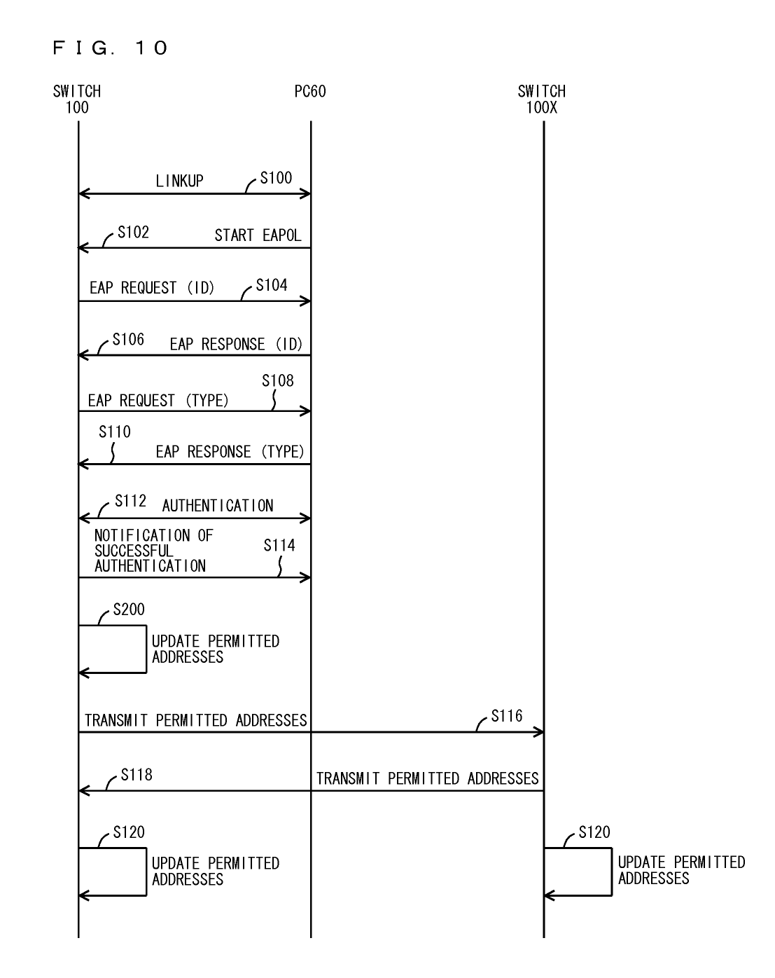

A specific example 2 of the frame reception process conducted by the switch 100 will be described by further referring to FIG. 9 to FIG. 11. FIG. 9 to FIG. 11 show an example in which an external device is newly connected to the switch 100 at the state shown in FIG. 8. The new external device is a terminal PC60 that has a MAC address of MAC_PC60.

### 2-1. Prior to having Mutual Authentication Conducted between the Switch and the Terminal

As shown in FIG. 9, discussed in the following is a case in which the terminal PC60 is newly connected to the port P503 of the switch 100. In this case, terminal PC60 transmits, to the switch 100 which is a connection partner, an EAPOL-start frame for requesting an authentication to start. The switch 100 that has received the EAPOL-start frame judges that the received frame is an EAP frame (step S12 in FIG. 5: YES). Next, the switch 100 refers to the authentication protocol list 410 and judges that the type of authentication is EAP_PC (step S14).

### 2-2. Authentication Process between the Switch and the Terminal

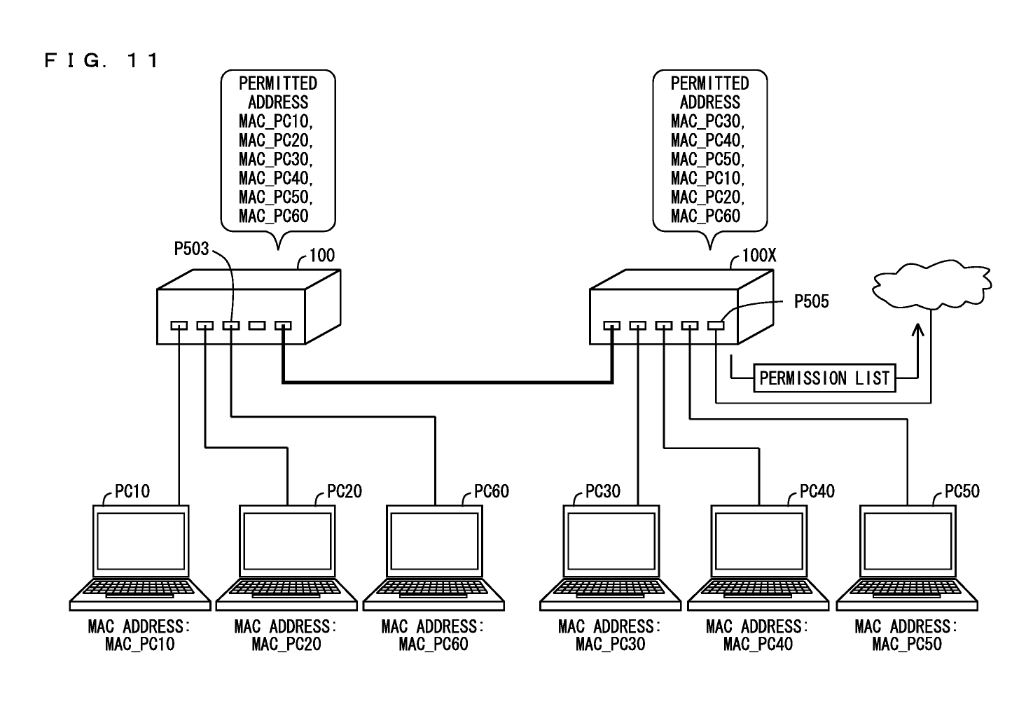

Mutual authentication between the switch 100 and the terminal PC60 is conducted as described in the following. FIG. 10 is a sequence diagram showing a flow of a process conducted between the switch and the terminal when the type of authentication is EAP_PC at step S16 in FIG. 5. Step S100 to step S114 in FIG. 10 are substantially identical to step S100 to step S114 in FIG. 7 except that the terminal PC60 behaves as an authentication client (supplicant). However, since the type of authentication in the present specific example 2 is EAP_PC, the switch 100 transmits, to the terminal PC60, an EAP request frame notifying EAP-MD5 as the type of EAP to be used for the authentication (step S108).

When the authentication at step S112 is successful, the switch 100 updates the permitted addresses stored in the first permission list 420 and adds the MAC address (MAC_PC60) of the terminal PC60 (step S200). Then, the switch 100 and the other switch 100X transmit, to each other, frames including permitted addresses stored in respective permission lists 420 (step S116, step S118). Next, the switch 100 and the other switch 100X each updates their own permission list 420. Details of step S116 to step S120 are similar to that shown in FIG. 7.

### 2-3. After having Mutual Authentication Conducted between the Switch and the Terminal

FIG. 11 shows a situation after having mutual authentication conducted when the terminal PC60 is newly connected to the switch 100. The MAC address (MAC_PC60) of the terminal PC60 which has been newly connected to the switch 100 is added to the second permission lists 420 included in the switch 100 and the other switch 100X.

As described in this example, when the terminal PC60 is additionally connected to the switch 100 after the successful mutual authentication between the switch 100 and the other switch 100X, the switch 100 adds the MAC address of the terminal PC60 to the first permission list 420. Then, the switch 100 transmits the updated first permission list 420 to the other switch 100X. As a result, similarly to the case described by using FIG. 8, frames transmitted/received to/from the newly connected terminal PC60 will be relayed instead of being discarded. The same applies, for example, when an additional switch other than the other switch 100X is connected to the switch 100.

Furthermore, for example, when the other switch 100X is connected to an additional switch as shown in FIG. 11, the other switch 100X may transmit, to the additional switch, the frame that has been received from the switch 100 and that includes the permitted addresses stored in the first permission list 420 of the switch 100. As described above, by adopting a configuration in which permitted addresses received from a switch connected to one hand are spread to a switch connected to the other hand, contents of permission lists used in MAC address authentication (i.e., MAC addresses of external devices whose frames should be permitted to be relayed) can be exchanged among switches, and thereby improved convenience can be provided. The permitted addresses may be spread to switches within a range of a single segment demarked by a router. The permitted addresses may be spread to the router itself. Then, the MAC addresses can be managed also by the router.

As described above, in the switch 100 according to the first embodiment of the present invention, when the other switch 100X is connected to the switch 100, mutual authentication is conducted between the switch 100 and the other switch 100X; and if the mutual authentication is successful, a frame permitted to be relayed by the other switch 100X is also relayed by the switch 100. Therefore, improved security can be achieved by the switch 100 according to the first embodiment.

In addition, in the switch 100 according to the first embodiment, when an authentication process is conducted between the switch 100 and the other switch 100X; if the mutual authentication is not successful, it is judged that the received frame is not eligible to be relayed and the received frame will be discarded, and if the mutual authentication has been successful between the switch 100 and the other switch 100X, the contents of the permission lists 420 are transmitted/received to/from the other switch 100X to be mutually reflected. More specifically, the switch 100 according to the first embodiment restricts an input of traffic from another switch 100X between which the mutual authentication has not been successful, and does not restrict an input of traffic from another switch 100X between which the mutual authentication has been successful. Therefore, in particular, the conventional problem of the ports regarding cascade connections becoming security holes can be suppressed. As a result, further improved security, particularly related to confidentiality, can be achieved by the switch 100 according to the first embodiment.

Furthermore, in the switch 100 according to the first embodiment: mutual authentication is conducted also with terminals that are directly connected; the (first) permission list 420 is changed such that relaying is permitted for frames received from terminals between which the mutual authentication has been successful; and the changed permission list 420 is transmitted to the other switch 100X. As a result, in the switch 100 according to the first embodiment, even when there is a change in the configuration at a switch after the mutual authentication of switches and the exchange of permitted addresses, exchanges of permitted addresses after the change in the configuration is conducted and thereby improved security and convenience can be provided.

### Second Embodiment

Described in a second embodiment of the present invention is a configuration further capable of using a VLAN (Virtual LAN), which is a virtual network, in the network relay device (switch) 100 of the first embodiment. In the following, descriptions of the second embodiment are provided only for those having a configuration or operation that is different from the first embodiment. It should be noted that, in the figures used for the second embodiment, components identical to those in the first embodiment are given identical reference characters, and detailed descriptions of those are omitted.

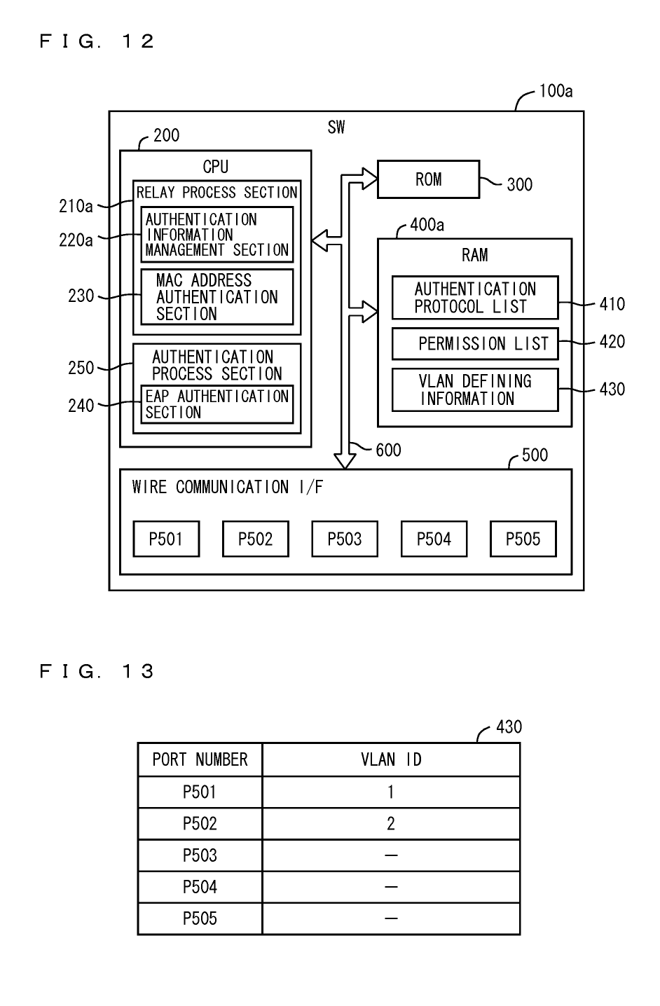

FIG. 12 schematically shows a configuration of a network relay device (switch) 100a according to the second embodiment of the present invention. The switch 100a of the second embodiment differs from the switch 100 of the first embodiment shown in FIG. 2 with regard to a relay process section 210a, an authentication information management section 220a, and a RAM 400a.

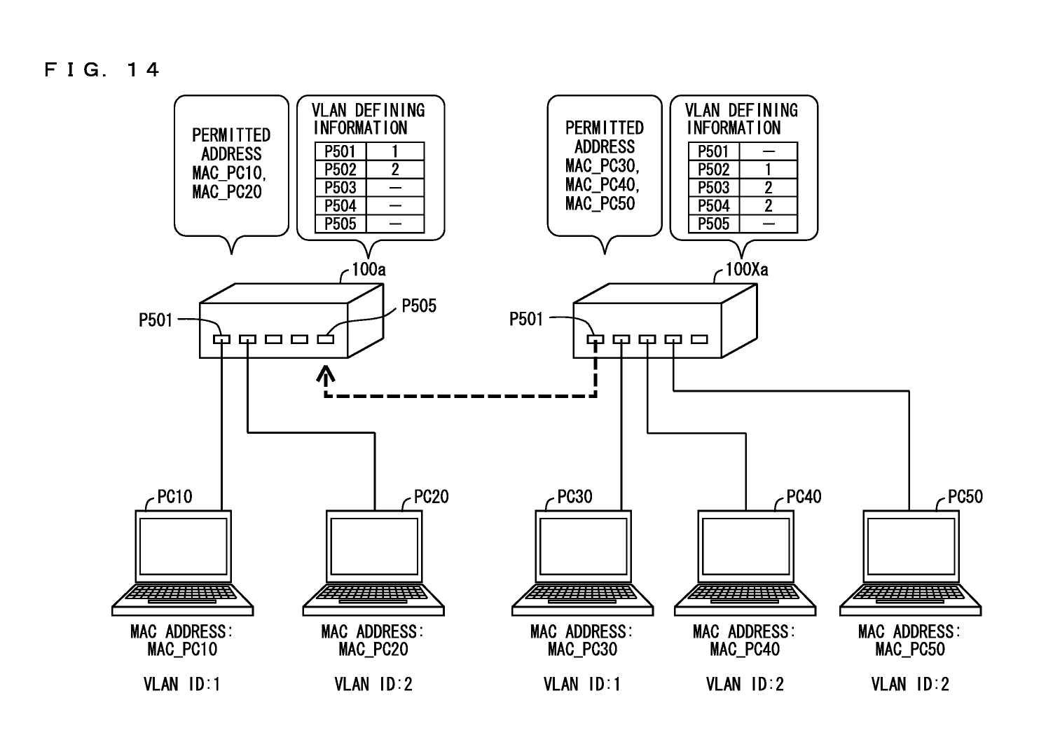

In addition to the authentication protocol list 410 and the permission list 420 described in the first embodiment, a VLAN defining information 430 is stored in the RAM 400a. FIG. 13 shows one example of the VLAN defining information 430. The VLAN defining information 430 is information that defines a virtually built subnetwork (hereinafter, referred to as a virtual network) instead of a physical mode of connection, and includes the port number field and a VLAN ID field. Identifiers of all the ports included in the switch 100a are stored as entries of the port number field. Port identifiers in the present embodiment are “P501” to “P505.” Stored in the VLAN ID field are identifiers of the virtual network (VLAN), which are pre-assigned to each of the ports stored in the port number field. The VLAN identifiers in the present embodiment are “1” and “2.”

For example, in FIG. 13, an external device connected to the port P501 identified by the port identifier P501 (i.e., the terminal PC10 shown in FIG. 1) is specified as belonging to a virtual network identified by a VLAN identifier “1.” Similarly, an external device connected to the port P502 identified by the port identifier P502 (i.e., the terminal PC20 shown in FIG. 1) is specified as belonging to a virtual network identified by a VLAN identifier “2.”

A frame reception process conducted by the switch 100a having the above described configuration is similar to that described in FIG. 5. However, based on the VLAN defining information 430, the relay process section 210a can build a virtual network (VLAN) for an external device connected to the switch 100a either directly, or indirectly via another switch 100Xa and the like. More specifically with regard to the frame relaying process (step S28 in FIG. 5), by referring to the VLAN defining information 430, the relay process section 210a assumes that ports assigned with VLAN identifiers of different virtual networks belong to different virtual networks, and conducts a frame relaying process. Therefore, according to the VLAN defining information 430 shown in FIG. 13, the terminal PC10 and the terminal PC20 in FIG. 1 are given different VLAN identifiers, and thereby are treated by the relay process section 210a as belonging to different virtual networks. As a result, relaying of frames is not conducted between the terminal PC10 and the terminal PC20.

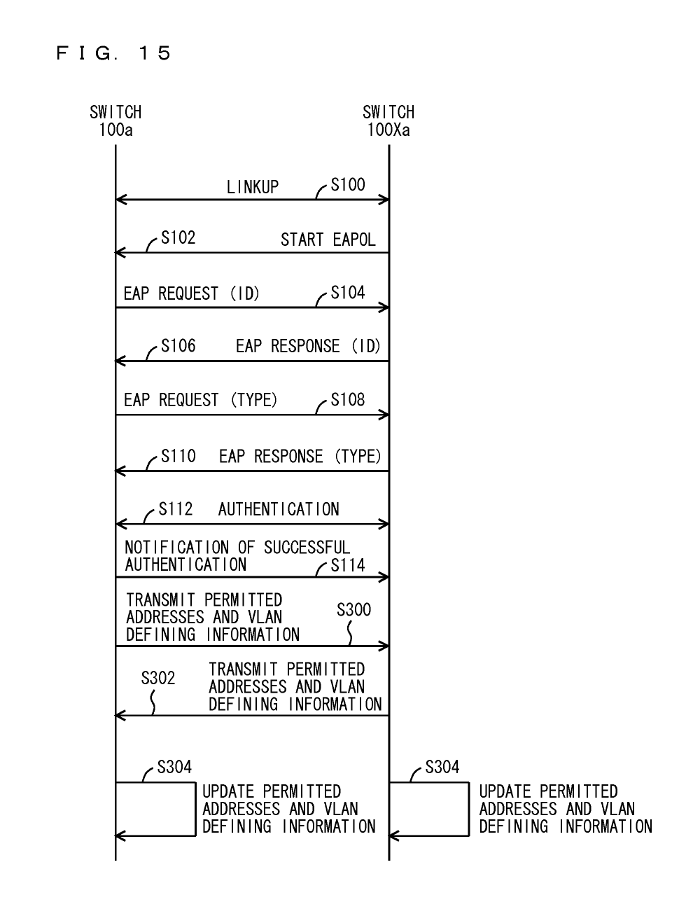

FIG. 14 shows a situation prior to having mutual authentication conducted when the other switch 100Xa and the switch 100a of the second embodiment are connected. The configuration of the other switch 100Xa is similar to the switch 100a shown in FIG. 12 except that the port P501 is set as a port for cascade connection. With regard to the ports of the other switch 100Xa, the port P501 has the port P505 of the switch 100a connected thereto, the port P502 has the terminal PC30 (MAC address: MAC_PC30; VLAN identifier: 1) connected thereto, the port P503 has the terminal PC40 (MAC address: MAC_PC40; VLAN identifier: 2) connected thereto, the port P504 has the terminal PC50 (MAC address: MAC_PC50; VLAN identifier: 2) connected thereto, and all connections are formed via lines.

Furthermore, contents of the authentication protocol list 410 and the second permission list 420 stored inside the other switch 100Xa are similar to those of the other switch 100X described in FIG. 6. In the VLAN defining information (in this specific example, referred to as second VLAN (virtual network) defining information) 430 stored inside the other switch 100Xa, a value of the VLAN ID field corresponding to the port P501 is “-,” a value of the VLAN ID field corresponding to the port P502 is “1,” and a value of the VLAN ID field corresponding to the port P503 and the port P504 is “2.”

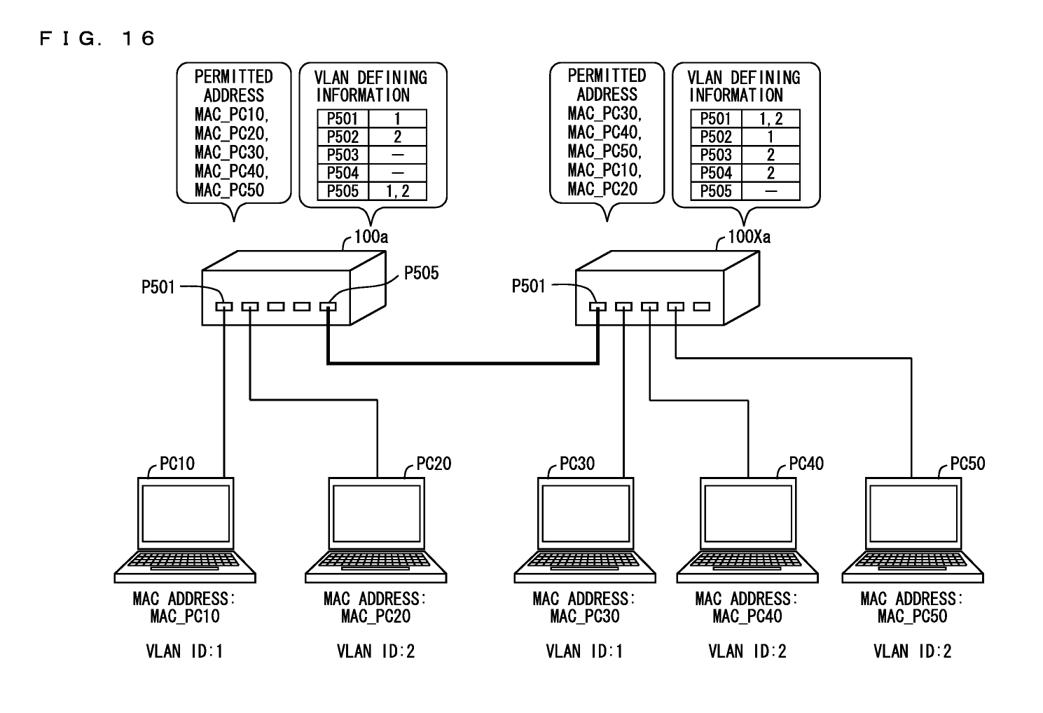

FIG. 15 is a sequence diagram showing a flow of a process (step S16 in FIG. 5: type of authentication is EAP_CAS) conducted when the other switch 100Xa is connected to the switch 100a of the second embodiment. It should be noted that step S100 to step S114 in FIG. 15 are identical to step S100 to step S114 described in FIG. 7.

After the mutual authentication has been successful with the other switch 100Xa, the authentication information management section 220a of the switch 100a transmits, to the other switch 100Xa, a frame including the permitted addresses stored in the first permission list 420 and information that is stored in the first VLAN defining information 430 and that defines the virtual network (step S300). Similarly, the other switch 100Xa that has received this frame transmits, to the switch 100a, a frame including the permitted addresses stored in the second permission list 420 of the other switch 100Xa and information that is stored in the second VLAN defining information 430 and that defines the virtual network (step S302).

The authentication information management section 220a of the switch 100a updates the permitted addresses stored in the first permission list 420 based on the permitted addresses included in the received frame, and updates defining information stored in its own VLAN defining information (in this specific example, referred to as first VLAN (virtual network) defining information) 430 based on the virtual-network-defining information included in the received frame (step S304). Similarly, the other switch 100Xa also updates the second permission list 420 and the second VLAN defining information 430 based on the permitted addresses and the virtual-network-defining information included in the received frame (step S304).

FIG. 16 shows a situation after having mutual authentication conducted when the other switch 100Xa is connected to the switch 100a shown in FIG. 14. Permitted addresses (MAC_PC30, MAC_PC40, and MAC_PC50) stored in the second permission list 420 of the other switch 100Xa are stored in the first permission list 420 stored inside the switch 100a, in addition to the MAC addresses (MAC_PC10, MAC_PC20) of the two terminals (PC10 and PC20) that are already connected to the switch 100a. Furthermore, “1” and “2” are stored as VLAN identifier corresponding to the port P505 in the first VLAN defining information 430 stored inside the switch 100a (step S304 in FIG. 15). Similarly, the permitted addresses (MAC_PC10 and MAC_PC20) stored in the first permission list 420 of the switch 100a are stored in the second permission list 420 stored inside the other switch 100Xa, in addition to the MAC addresses (MAC_PC30, MAC_PC40, and MAC_PC50) of the three terminals (PC30, PC40, and PC50) already connected to the other switch 100Xa. Furthermore, “1” and “2” are stored as VLAN identifier corresponding to the port P501 in the second VLAN defining information 430 stored inside the other switch 100Xa (step S304 in FIG. 15).

Diagrammatic representation of a process conducted when the type of authentication is EAP_PC will be omitted, but it is basically similar to the process described in FIG. 10, and the differences from the previously described process include updating the VLAN defining information 430 at step S200 in addition to the permission list 420, transmitting and receiving the virtual-network-defining information at step S116 and step S118 in addition to the permitted addresses, and updating the VLAN defining information 430 at step S120 in addition to the permission list 420.

In addition to the process conducted in the switch 100 according to the first embodiment as described above, in the switch 100a according to the second embodiment of the present invention, the contents of the VLAN defining information 430 are transmitted/received to/from the other switch 100Xa to be mutually reflected when the mutual authentication with the other switch 100Xa or the authentication with the terminal is successful. As a result, the switch 100a according to the second embodiment enables to easily configure settings regarding the virtual network (VLAN) while improving security.

### Modification 1

The configurations of the switches shown in each of the embodiment described above are merely examples and other configurations may be adopted. For example, as described in the following, modifications such as an omission of a part of the components and a further addition of components can be devised.

Instead of using layer 2 switches to relay frames by using MAC addresses, the switches in each of the embodiments may be layer 3 switches that are further capable of relaying packets by using IP addresses. Furthermore, the switches in each of the embodiments may be so-called access points capable of relaying packets of wireless communication via wireless-communication interfaces.

Furthermore, in the switches in each of the embodiments described above, although the authentication protocol lists, the permission lists, and the VLAN defining information are stored in a RAM, they may be stored in another type of storage medium (for example, flash ROM).

Furthermore, descriptions have been provided for the switches in each of the embodiments as, the CPU including the relay process section and the EAP authentication section, while the relay process section further including the authentication information management section and the MAC address authentication section. In addition, descriptions of the functions executed in each of the process sections have been provided. However, the allocations of each of the process sections and the functions accomplished by each of the process sections are merely examples, and may be arbitrarily changed depending on the configuration of the switch.

Furthermore, among the functions of the relay process section described in the embodiments, the frame relaying function may be a function attained by a physical chip that forms a wire communication interface, and the other functions (the function of determining whether a received frame is eligible to be relayed, the function of the authentication information management section, and the function of the MAC address authentication section) of the relay process section may be functions attained by the CPU. In such a case, all the functions of the relay process section are attained through a cooperation of the CPU and the physical chip forming the wire communication interface. For example, the functions of the relay process section, the EAP authentication section, the authentication information management section, and the MAC address authentication section may all be included inside the physical chip forming the wire communication interface.

### Modification 2

In the embodiments described above, the switch includes: the MAC address authentication section for conducting a MAC address authentication of a received frame; and the EAP authentication section for conducting, when an external device is connected, mutual authentication between the switch and the connect external device. In other words, a function of RADIUS (Remote Authentication Dial-In User Service) is built in the switch. However, a dedicated RADIUS server may be provided separate from the switch, and this external RADIUS server may conduct the actual MAC address authentication and the mutual authentication with a connected external device. When a dedicated RADIUS server separate from the switch is provided, the functions of the MAC address authentication section and the EAP authentication section can be achieved by having the MAC address authentication section and the EAP authentication section transmit authentication requests to the RADIUS server to obtain authentication results as responses to the transmissions.

Furthermore, in each of the above described embodiments, descriptions have been provided for the examples using, as the authentication protocol determined in advance, EAP-MD5 of IEEE 802.1X when the type of authentication is EAP_PC, and EAP-TLS of IEEE 802.1X when the type of authentication is EAP_CAS. However, authentication protocols other than those described above as examples may be adopted.

Examples of the authentication protocols that can be adopted include EAP-TTLS (extensible authentication protocol-tunneled transport layer security, PEAP (Protected Extensible Authentication Protocol), LEAP (Lightweight Extensible Authentication Protocol), and other original methods using EAP protocol.

Furthermore, instead of the authentication protocol conforming to EAP protocol of IEEE 802.1X, the following authentication protocol may be used. Specifically, MAC addresses of external devices (other switches, terminals, and the like) that should be permitted to be connected are stored inside the switch in advance. Then, when an external device is connected and if the MAC address of the external device is a preregistered MAC address that should be permitted for connection, the EAP authentication section treats the external device as a partner between which the mutual authentication has been successful. By adopting such a configuration, an administrator of the switch or the like can designate in advance an external device that should be permitted for connection.

### Modification 3

In the above described embodiments, examples of the authentication protocol list, the permission list, and the VLAN defining information have been shown in a table format. However, these tables are merely examples, and the format thereof may be arbitrarily determined without departing from the spirit and scope of the invention. For example, fields other than the fields described above may be included. In addition, direct-mapped method can be used on each of the tables. Furthermore, it is also desirable if each of the tables is configurable by the user.

Specifically, although the permission lists only store, without any distinctions of the port from which a frame has been received, transmission source MAC addresses that are eligible to be relayed; modifications as described in the following may be adopted. For example, by adding the port number field to the permission list, the transmission source MAC addresses, from which frames permitted to be relayed are received, may be managed by every port. Furthermore, by providing a transmission source MAC address field and a relay-eligibility field instead of the permitted address field, a frame's eligibility/ineligibility to be relayed may be set for every transmission source MAC address.

It should be noted that, in each of the embodiments described above, although the CPU has achieved every configuration of the switch by executing a firmware or a computer program stored in a memory, each configuration of the present invention may be achieved by hardware or software.

Furthermore, when one part or all the functions of the present invention are achieved by software, the software (computer program) may be provided as being stored in a computer readable storage medium. In the present invention, the term “computer readable storage medium” is not limited to portable storage media such as flexible disks and CD-ROMs, but also includes internal storage devices of computers such as various RAMs, ROMs, and the like, and external storage devices such as hard disks and the like that are fixed on the computer.

While the invention has been described in detail, the foregoing description is in all aspects illustrative and not restrictive. For example, elements that are additional in light of the scope and spirit of the present invention can be omitted as appropriate. It will be understood that numerous other modifications and variations can be devised without departing from the scope of the invention.

What is claimed is:

1. A network relay device for relaying frames received from external devices, the network relay device comprising:
an authentication process section for conducting, when a separate network relay device is connected to said network relay device as an external device, mutual authentication between said network relay device and the separate network relay device in accordance with an authentication protocol that is determined in advance; and
a relay process section for determining whether frames that said network relay device receives from an external device are relay-eligible, and for relaying received frames determined to be relay-eligible; wherein
on the condition that the mutual authentication by the authentication process section has been successful, the relay process section relays, through said network relay device, the frames received from the separate network relay device.

2. The network relay device according to claim 1, further comprising a storing section storing a first permission list for using information included in the received frames to designate frames eligible for relaying through the network relay device, wherein
the relay process section includes:
an authentication information management section for transmitting content of the first permission list to a separate network relay device between which mutual authentication has been successful, and for receiving, from the separate network relay device between which the mutual authentication has been successful, content of a second permission list for designating in the separate network relay device relay-eligible frames, and reflecting the content of the received second permission list onto the first permission list; and
a determination process section for determining, in accordance with the second-list reflecting first permission list, whether frames received from an external device are relay-eligible.

3. The network relay device according to claim 2, wherein:
the storing section further stores first virtual-network-defining information defining a virtual subnetwork built by an external device connected to said network relay device either directly, or indirectly via a separate network relay device;
the authentication information management section further transmits content of the first virtual-network-defining information to a separate network relay device between which mutual authentication has been successful, and further receives, from the separate network relay device between which the mutual authentication has been successful, content of second virtual-network-defining information defining a virtual subnetwork built by an external device connected to the separate network relay device either directly, or indirectly via still another separate network relay device, and reflects the content of the received second virtual-network-defining information onto the first virtual-network-defining information.

4. The network relay device according to claim 2, wherein:
the authentication process section furthermore conducts, when a frame-transmitting terminal is connected as an external device to said network relay device, mutual authentication between said network relay device and the terminal in accordance with an authentication protocol that is determined in advance; and
the authentication information management section furthermore changes, if the mutual authentication with the terminal has been successful, the content of the first permission list so as to permit relaying of frames received from the terminal, and furthermore transmits the content of the changed first permission list to the separate network relay device between which the mutual authentication has been successful.

5. The network relay device according to claim 3, wherein
the authentication process section furthermore conducts, when a terminal that transmits frames is connected as an external device to the network relay device, mutual authentication between the network relay device and the terminal in accordance with an authentication protocol that is determined in advance, and
the authentication information management section furthermore changes, if the mutual authentication with the terminal has been successful, the content of the first permission list so as to permit relaying of frames received from the terminal, and furthermore transmits the content of the changed first permission list to the separate network relay device between which the mutual authentication has been successful.

6. The network relay device according to claim 5, wherein
the authentication information management section furthermore transmits, if the mutual authentication with the terminal has been successful, the content of the first virtual-network-defining information to the separate network relay device between which the mutual authentication has been successful.

7. The network relay device according to claim 1, wherein
the authentication process section has functions of both an authentication client based on IEEE 802.1X and an authentication server based on IEEE 802.1X.

8. The network relay device according to claim 1, wherein
when the separate network relay device is connected to the network relay device and when a MAC address of the separate network relay device is registered in the network relay device in advance as a MAC address to be permitted for connection, the authentication process section treats the separate network relay device as a partner between which mutual authentication has been successful.

9. A method executed by a network relay device for controlling relay frames received from external devices, the method comprising:
a step of judging whether an external device connected to the network relay device is a separate network relay device;
a step of conducting, when the connected external device is a separate network relay device, mutual authentication between the network relay device and the separate network relay device in accordance with an authentication protocol that is determined in advance;
a step of exchanging, with the separate network relay device if the mutual authentication between the network relay device and the separate network relay device has been successful, contents of permission lists which are stored in advance to designate, using information included in received frames, frames that are relay-eligible;
a step of reflecting content of a permission list acquired by an exchange and stored in the separate network relay device between which the mutual authentication has been successful, onto a permission list stored in the network relay device; and
a step of determining, in accordance with the reflected permission list, whether frames received from the external device are relay-eligible.

10. The relay control method according to claim 9, further comprising:
a step of judging whether the external device connected to the network relay device is a terminal that transmits frames;
a step of conducting, when the connected external device is a terminal, mutual authentication between the network relay device and the terminal in accordance with an authentication protocol that is determined in advance; and
a step of changing, if the mutual authentication with the terminal has been successful, content of the permission list stored in the network relay device so as to permit relay of frames received from the terminal, and transmitting the content of the changed permission list to the separate network relay device between which the mutual authentication has been successful.
